(19) United States
(12) Patent Application Publication
(10) Pub. No.: US 2005/0057466 A1
(43) Pub. Date: Mar. 17, 2005

(54) Driving method for low consumption LCD modules

(75) Inventors: Leonardo Sala, Pont Saint Martin (IT); Daniele Domanin, Aosta (IT); Roberto Gariboldi, Lacchiarella (IT)

Correspondence Address: SEED INTELLECTUAL PROPERTY LAW GROUP PLLC, 701 FIFTH AVENUE, SUITE 6300, SEATTLE, WA, 98104-7092, US

(73) Assignees: STMicroelectronics S.r.l., Agrate Brianza (IT); DORA S.p.A., Chatillon (IT)

(21) Appl. No.: 10/897,381

(22) Filed: Jul. 22, 2004

(30) Foreign Application Priority Data
Jul. 24, 2003 (IT) MI2003A001518

(51) Int. Cl. G09G 3/36

(52) U.S. Cl. 345/87

(57) ABSTRACT

A method for driving low consumption LCD modules, the LCD modules having a multiplicity of display elements located at the intersections of a matrix having a plurality of row electrodes and a plurality of column electrodes, the method includes the phases of applying an M bit electrical digital signal to at least one row electrode at a time, subdivided in a plurality of time intervals equal to 2^{M}−1, the electrical digital signal suitable for illuminating each of the display elements with a predefined luminosity level chosen from among 2^{M} luminosity levels, each of the M bits is applied for a preset duration, then reducing the preset duration of each of the M bits in accordance with a predefined scale factor K and subdividing the M bits in (2^{M}−1)/K plurality of time intervals.

### BACKGROUND OF THE INVENTION

1. Field of the Invention

The present invention refers to a driving method for low consumption LCD modules.

2. Description of the Related Art

By LCD module it is meant an LCD display device (Liquid Crystal Display) basically made up of a row and column matrix of electrodes which, suitably driven by means of the application of a voltage signal, determine a change in the optical behavior of the liquid crystal interposed at the crossing points, the so-called pixels.

A method often used for driving an LCD display and known as Improved Alt & Pleshko (IA&P) requires exciting of a single row electrode for an elementary period of time by means of a single selection pulse and the simultaneous excitation of the column electrodes; voltage values suitable for determining the turning on or turning off of all the pixels that belong to that single row are applied to the column electrodes. For a further elementary period of time there will be the excitation of another row electrode and so on until the scanning of the last row electrode is completed; therefore, if the row electrodes are a number N and T is the elementary period of time, also called frame, the time needed for the scanning of all the rows will be given by N*T.

Another method used for driving an LCD display is known as Multi-Line Addressing (MLA) and requires the simultaneous excitation of more than one row electrode, by means of selection pulses prolonged for a time interval that is substantially the same as the time interval T of the Improved Alt & Pleshko driving, multiplied by the number of rows simultaneously excited, and the simultaneous excitation of the column electrodes; voltage values suitable for determining the turning on or turning off of all the pixels that belong to the simultaneously excited rows are applied to the column electrodes.

Considering that for a pixel the determination of the white and the black varies by applying respectively to the pixel two different levels of voltage, an effective turn-on voltage (Von) and an effective turn-off voltage (Voff), the generation of intermediate grey levels between the voltages Von and Voff is determined by the application of intermediate levels of effective voltage between Von and Voff to the pixel. As can be seen in FIG. 1, as the effective voltage applied Ve grows, the transmittance Tr of the pixel is reduced displaying darker grey levels.

To obtain intermediate values of effective voltage corresponding to the grey levels required, the waveform of the voltage signal applied only to the columns has to be modulated as the voltage signals applied to the rows do not take part in determining the grey levels.

FIGS. 2a-2c show the graphs of the waveforms of a voltage signal applied to a column of a matrix of an LCD display for determining two grey levels G1 and G2 in addition to the white W and black B value according to the Improved Alt & Pleshko driving, in the case of width modulation SAM (FIG. 2a), in frequency or otherwise called Frame Rate Control (FRC) S_{FRC} (FIG. 2b) and pulse width or otherwise called Pulse Width Modulation (PWM) S_{PWM} (FIG. 2c). The number of switchings of the waveforms of the signals applied to the columns in the case of pulse width modulation (PWM) (FIG. 2c) is greater than switches in frequency (FIG. 2b) or in width (2a).

While the PWM technique allows to define by means of a high number of switchings of the waveforms the level of grey of each pixel at the end of only one scanning of the matrix, the frequency modulation defined Frame Rate Control (FRC) requires a plurality of frames in each of which the pixels can be only either completely off or completely on, without switchings inside the excitation time of the pixel.

As the number of grey shades requested increases, the PWM technique presents as its first problem that of requiring turn-on pulses having shorter and shorter time extension, which correspond to frequencies at which the LCD crystal tends no longer to reply to the electric excitation. As the switching increase, the consumption of current also increases. For the determination of the length of the activation pulse of the pixel, the PWM technique also requires access to the complete grey codification of the pixel, as cumbersome as the number of grey shades (or of colors) requested is high.

The fundamental advantage of the FRC technique compared to the PWM technique lies then in the possibility of defining in each frame the on/off state of each pixel by reading only one bit of the code that defines the level of grey of the pixel permitting a great simplification of the logics of selecting the waveforms, and a drastic reduction of the band requested to access the memory needed for the codification of the levels of each pixel.

In addition the adoption of the PWM techniques coupled with simultaneous driving techniques of multiple rows (MLA) determines the need for considerable calculation resources.

One of the main disadvantages associated to the FRC technique is given by the appearance of the phenomenon known as flickering, caused by the alternation of frames in which the pixel is on and of frames in which the pixel is off. In the absence of adequate devices, this alternation determines the perception of the instability of the image, that can be recuperated at the price of an increase of the scanning frequency, which entails an increase in consumption.

In extreme synthesis, as the number of grays or colors whose display is required increases, with PWM technique the consumption of the display is kept constant but the complexity of the calculation of the resulting waveform increases, with FRC technique the complexity can be handled, also in MLA, but the scanning frequency required to annul the flickering increases to such a point that the consumption of the display, well over that which would be in PWM, already for 16 levels of grey, are no longer acceptable.

### BRIEF SUMMARY OF THE INVENTION

In view of the state of the technique described, the disclosed embodiments of the present invention provide for a method for driving LCD modules that has low consumption and is easy to apply.

In accordance with one embodiment of the present invention, a method for driving LCD modules having a multiplicity of display elements located at the intersections of a matrix having a plurality of row electrodes and a plurality of column electrodes is provided. The method includes the phases of: applying an M bit electrical digital signal to at least one row electrode at a time, subdivided into a plurality of time intervals equal to 2^{M}−1; said electrical digital signal suitable for illuminating each of said display elements with a predefined luminosity level chosen between 2^{M} luminosity levels; each of said M bits is applied for a preset duration; and the duration of each of said M bits is reduced in accordance with a predefined scale factor K and said M bits are divided in (2^{M}−1)/K pluralities of time intervals.

In accordance with another embodiment of the invention, a method for driving LCD modules is provided, the LCD modules having a plurality of display elements associated with a plurality of row electrodes and a plurality of column electrodes in a matrix, the method including the steps of illuminating each of the display elements with a predefined luminosity level chosen from among 2^{M} luminosity levels by applying an M-bit electrical digital signal to at least one row electrode at a time, the M-bit electrical digital signal subdivided into a plurality of time intervals equal to 2^{M}−1, each of said M-bits is applied for a preset duration; and reducing the preset duration of each of said M-bits in accordance with a predefined scale factor K and subdividing M-bits into (2^{M}−1)/K plurality of time intervals.

In accordance with yet another embodiment of the invention, a method for driving LCD modules is provided, the LCD modules having a multiplicity of display elements coupled to a plurality of row electrodes and a plurality of column electrodes arranged in a matrix, the method comprising: illuminating each of the display elements with a predefined luminosity level chosen from among 2^{M} luminosity levels by applying an M-bit electrical digital signal to at least one row electrode at a time, the M-bit electrical digital signal subdivided into a plurality of time intervals equal to 2^{M}−1, each of said M-bits is applied for a preset duration; and reducing the preset duration of each of said M-bits in accordance with a predefined scale factor K.

The foregoing embodiments of the present invention ensure the feasibility of MLA techniques, the simplicity of FRC modulation, and reduced values of the scanning frequency of the same PWM.

### BRIEF DESCRIPTION OF THE SEVERAL VIEWS OF THE DRAWING(S)

The characteristics and the advantages of the present invention will appear evident from the following detailed description of an embodiment thereof, illustrated as non-limiting example in the enclosed drawings, in which:

FIG. 1 is a graph of the transmittance of a pixel in function of the effective voltage applied to a column;

FIGS. 2a-2c are graphs of the waveforms of a voltage signal applied to a column of a matrix of an LCD display, for determining two grey levels G1 and G2, for the white W and for the black B, with a width modulation (FIG. 2a), in frequency (FIG. 2b), and PWM (FIG. 2c) according to an Improved Alt & Pleshko type driving;

FIG. 3 shows an explanatory diagram for the assessment of the weight of the bits for a scale with 8 grey levels in a frame report control procedure (FRC);

FIG. 4 shows an explanatory diagram for the assessment of the weight of the bits for a scale with 8 grey levels in a frame report control procedure (FRC) alternative to that of FIG. 3;

FIG. 5 shows an explanatory diagram for the assessment of the weight of the bits for a scale with 8 grey levels in a procedure in accordance with the present invention;

FIG. 6 shows an explanatory diagram for the assessment of the weight of the bits for a scale with 16 grey levels in a frame report control procedure (FRC);

FIGS. 7, 8 and 9 show an explanatory diagram for the assessment of the weight of the bits for a scale with 16 grey levels in three different cases in a procedure in accordance with the present invention.

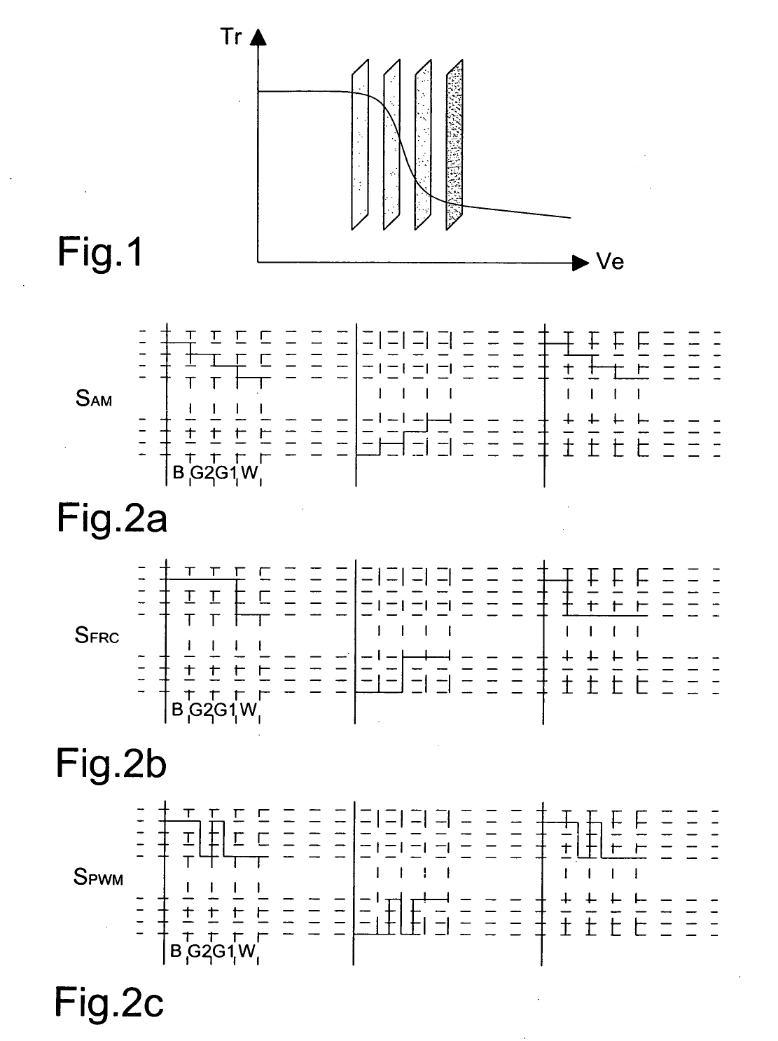

### DETAILED DESCRIPTION OF THE INVENTION

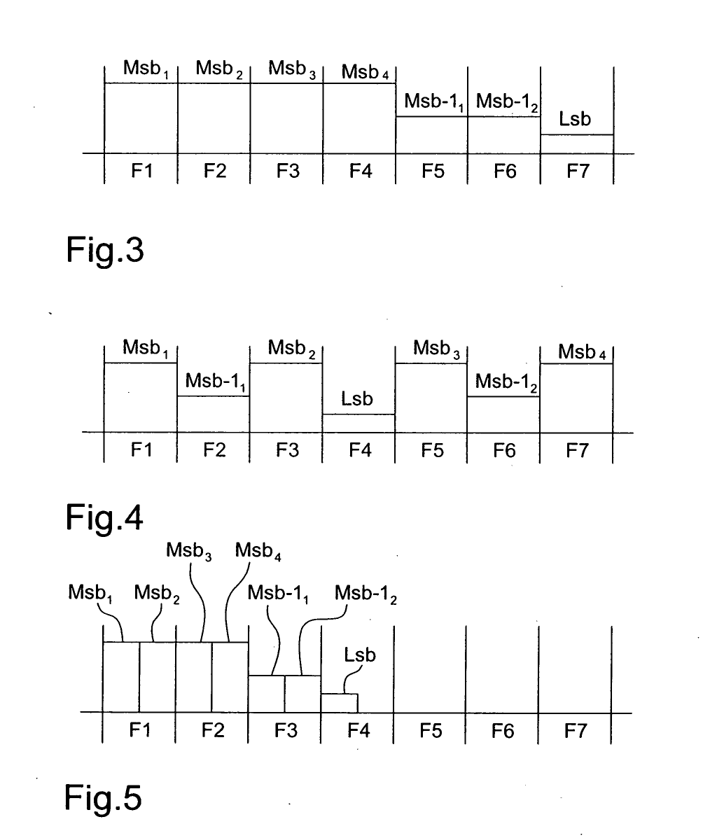

The present invention analyzes more deeply the problem of the flickering that afflicts the FRC for scanning frequencies that are not adequately high. In fact, the instability of the image in FRC derives from the fact that when grey shades that are very close to white are present, they are obtained by means of turning on pixels in a few frames and turning off the same pixels in a lot of frames. To the extent to which suitable alternation between these two values can be introduced, the time that passes between two successive turn-ons is as long as the grey is pale. It is exactly this alternation that is too slow that determines the instability. As has been anticipated in FRC access can be made to a single codification bit of the grey of each pixel in each frame, according to a suitable predetermined order. Normally the less significant bit LSB is assessed in only one frame, the immediately more significant MSB-1 bit for a double number of frames and the more significant bit MSB for a quadruple number of frames, as can be seen in FIG. 3 in the case of 8 grey levels and 7 frames F1-F7.

This method of proceeding determines the generation of grey weighing proportionally the duration of the various instants in which the various bits of increasing weight are applied, having as multiple the duration of the elementary scanning pulse.

A re-ordering of the frames is possible which permits greater uniformity in the time order with which the various bits are assessed, to the advantage of the reduction of the flicker and of the scanning frequency requested, as can be seen in FIG. 4 where the bit sequence has been alternated.

The innovative idea consists in applying a suitable scale factor, to be chosen according to the criteria here below indicated, to the duration of the instants of time defined by the frames. Assuming, for simplicity, that a factor equal to two times all the bits is applied, except for the less significant that are still weighed on a whole number of frames, thus obtaining the appearance of only one potential additional switching (that is made only if the bits assessed in that elementary period of time are different) within the elementary period of time (in particular in the frame in which the single pixel requires the assessment of the LSB) with the fundamental advantage that the waiting time between two successive turn-on instants of the pixels is immediately halved, enabling the number of frames and the frequency to be halved and a considerable (even though not linearly proportional) reduction of the associated consumption. The redistribution of the assessment of the various bits is shown in FIG. 5.

Continuing with increasing division factors (multiples of two), the scanning frequency appears even further reduced, but within the elementary period of time the possible switchings are more numerous, with the consequent increase of consumption, although the fundamental concept of access to only one bit at a time is kept.

In other terms, by proceeding in the described method a PWM component (in each case observing the access in memory to only one bit at a time and thus simple to handle) is introduced on the starting FRC modulation, limited to what is strictly necessary for the reduction of the frequency and not applied indiscriminately to all the grey shades.

It is very important to be able to identify the optimal division factor.

A first method for determining this factor is based on the minimization of consumption.

Having obtained experimentally the path of the minimum frequency at which there is no flickering for various grey shades, the ratio between the consumption (that can be medium or peak, in function of the coherent meaning that can be assigned to the parameters Cf and Cp that describe the frame switchings of a certain pixel) compared to the worst consumption relating to the white and black can be created in a model as:
I₀*2^{(γ}^{_{f}}^{β}^{_{f}}⁾(1−2^{(β}^{_{f}}^{f)}*C_{f}+2^{(-β}^{_{f}})*Cₚ*(βₜ−β_{f}))
where γ_{f} is a empirical factor of between 0.5 and 0.7 and takes account of the increase frequency needed to eliminate the flickering in FRC, β_{f} and βₜ are respectively the number of codification bits handled in FRC and the number of total bits on which the grey is codified, while I₀ is a suitable size with current dimensions (A) that is linked by means of a suitable scale factor to the maximum consumption of current of the same panel in white and black at the refresh rate of 75 Hz.

The values that C_{f} and Cₚ can assume depend on the manner in which the new sequence FRC that will have to minimize the consumption has been constructed, and they express respectively the probability of switching of the FRC component and of the PWM component.

The sequence resulting from the reduction of the number of frames will have to assess the bits for a shorter duration than the row time, combined together so as to reduce the number of possible additional switchings, as shown in the diagrams in FIGS. 7, 8 and 9.

The sequence will allow compatibly with what was said previously, the reduction of the operating frequency distributing equally the instants of time in which a bit is assessed, with particular attention to the less significant bits which, for the fact of being assessed less often, can ingenerate flicker and consequently request higher frequencies and increasing consumption.

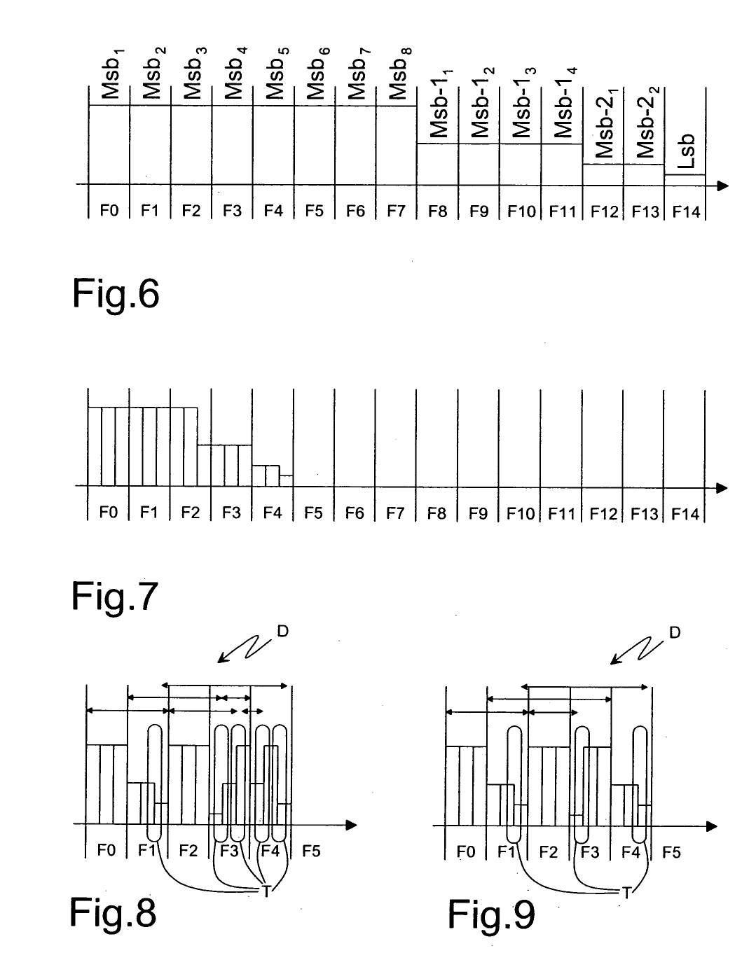

FIG. 6 shows an explanatory diagram for the assessment of the weight of the bits for a scale with 16 grey levels and 15 frames F0-F14, in a frame report control procedure (FRC).

FIGS. 7, 8 and 9 show an explanatory diagram for the assessment of the weight of the bits for a scale with 16 grey levels in three different cases in accordance with the present invention, where a scale factor equal to 3 has been applied.

In FIG. 7 a non-uniform distribution of the bits having the same weight can be noted, in fact the bits having the same weight are grouped together.

In FIG. 8 an improved distribution of the bits having the same weight can be noted and thus less flickering. In fact, the bits having the same weight follow each other at distances D more or less equally distributed, but there are 5 column transitions T within the frames.

In FIG. 9 a good distribution D of the bits having the same weight can be noted, and there are only 3 column transitions T within the frames.

Tables 1 and 2 give the values of the typical consumption in relation to the worst consumption in white and black calculated with the previous formula.

TABLE 1

| Pure | | | | | | | | Pure | | | |
|---|---|---|---|---|---|---|---|---|---|---|---|
| PWM | | | | | | | | FRC | | | |
| 0 | 1 | 2 | 3 | 4 | 5 | 6 | 7 | 8 | Cf | Cp | Bt |
| 8 | 5.68 | 4.31 | 3.7 | 3.79 | 4.63 | 6.35 | 9.26 | 13.87 | 0.50 | 1.00 | 8 |
| 7 | 4.93 | 3.73 | 3.26 | 3.46 | 4.38 | 6.16 | 9.12 | — | 0.50 | 1.00 | 7 |
| 6 | 4.17 | 3.16 | 2.83 | 3.13 | 4.13 | 5.97 | — | — | 0.50 | 1.00 | 6 |
| 5 | 3.41 | 2.58 | 2.39 | 2.8 | 3.88 | — | — | — | 0.50 | 1.00 | 5 |
| 4 | 2.65 | 2.01 | 1.96 | 2.47 | — | — | — | — | 0.50 | 1.00 | 4 |
| 3 | 1.89 | 1.44 | 1.52 | — | — | — | — | — | 0.50 | 1.00 | 3 |
| 2 | 1.14 | 0.86 | — | — | — | — | — | — | 0.50 | 1.00 | 2 |
| 1 | 0.38 | — | — | — | — | — | — | — | 0.50 | 1.00 | 1 |

TABLE 2

| Pure | | | | | | | | Pure | | | |
|---|---|---|---|---|---|---|---|---|---|---|---|
| PWM | | | | | | | | FRC | | | |
| 0 | 1 | 2 | 3 | 4 | 5 | 6 | 7 | 8 | Cf | Cp | Bt |
| 6 | 4.05 | 2.74 | 1.91 | 1.43 | 1.26 | 1.36 | 1.75 | 2.5 | 0.09 | 0.75 | 8 |
| 5.25 | 3.48 | 2.31 | 1.58 | 1.19 | 1.07 | 1.22 | 1.64 | — | 0.09 | 0.75 | 7 |
| 4.5 | 2.91 | 1.88 | 1.25 | 0.94 | 0.89 | 1.07 | — | — | 0.09 | 0.75 | 6 |
| 3.75 | 2.34 | 1.45 | 0.93 | 0.69 | 0.7 | — | — | — | 0.09 | 0.75 | 5 |
| 3 | 1.77 | 1.02 | 0.6 | 0.45 | — | — | — | — | 0.09 | 0.75 | 4 |
| 2.25 | 1.2 | 0.59 | 0.27 | — | — | — | — | — | 0.09 | 0.75 | 3 |
| 1.5 | 0.64 | 0.16 | — | — | — | — | — | — | 0.09 | 0.75 | 2 |
| 0.75 | 0.07 | — | — | — | — | — | — | — | 0.09 | 0.75 | 1 |

As can be seen from the Tables 1 and 2, a minimum consumption is present that determines the value of the scale factor and that suggests the exact use of the adoption of a mixed solution that is not purely FRC and not PWM. In other terms, the adoption of PWM can be limited to only the less significant bits, introducing the eventual switching (differently from the deterministic switchings of the traditional PWM) in a limited number of instants of time, reducing the operating frequency in comparison to the traditional FRC and the associated consumption, keeping finally as FRC the possibility of accessing only one grey codification bit for the assessment in a given instant of the state of the pixel itself.

What happens generally, with the exception of some particular situations, is that generating the grays in pure FRC the number of frames requested rises exponentially with the codification bits, and because of the less significant bits, the minimum scanning frequency increases, according to the empirical law of the exponential type already described. From here the high consumption decreases, proportionally linearly with the scanning frequency.

On the contrary, operating in Pure PWM, that is with FRC=1, with all the switchings potentially present in the row time of all the frames (all identical) in a high number, the consumption increases more than the benefit of the reduced frequency.

For example, wanting to display 256 grey levels codified on 8 bits, the result is that, for a given panel taken as reference, in the case of pure FRC (255 frames) the consumption explodes because of the high frequency at 14 mA and on the contrary, in the case of pure PWM the consumption stays high anyway because of the high number of switchings that can occur. Instead, handling a number of bits equal to 3 in FRC (therefore on 2\hat{ }(3−1)=7 frames) and 5 bits in PWM (with 32 divisions within the elementary pulse) a definite minimum with consumption of little more than 3.5 mA is achieved.

A second method for the determination of the scale factor is based on the possibility of obtaining a number of frames resulting particularly suitable for the use of the technique known as Phase Tiling, after the application of the reduction factor of the frames, which in turn offers a method for the reduction of the frequency and thus of the consumption.

The Phase Tiling technique provides for the application of various bit assessment sequences to various pixels of the display, following a special scheme. The advantage of this approach consists in displaying different bits on different pixels at the same instant, so that, for example when on all the display the weakest grey is displayed it does not happen that in one frame only all the pixels are on and in the others they are off, but in each instant an equal number of pixels is on. This guarantees a substantial reduction of the flicker, of the scanning frequency and with it the consumption. The various sequences applied to the various families of pixels are known as phases.

Several study projects regarding Phase Tiling show in particular the use of having available in particular 7/11/13 phases, obtainable in an optimal manner from the availability of 7/11/13 frames. Therefore, with the technique described in general a given number of starting frames can be referred back to a number of frames equal to the number suggested for an optimal use of Phase Tiling.

The technique that is herein described can be applied very well to being combined with codifications to non-binary weights of the various bits, useful for generating grays that are not uniformly distributed in effective value; in fact, in addition to being compatible, it gives place to solutions that are not common, in terms of the possibility to choose in a wider spectrum of division factors of the basic sequence FRC.

The codifications to non-binary weights are codes in which the weights that are not more than increasing powers of 2 are associated to the various bits of a digital word. In fact there is a certain number of these codes that permit, within the sphere of LCD display driving, that a non-uniform distribution of the voltages (Vrms) is obtained so as to have available a greater resolution in voltage in the linear operation section, with high slope, of a liquid crystal mix and a lower resolution in the section for reduced slope, so as to obtain greater uniformity of the luminous response of the display.

As an example the interconversion from 31 to 33 frames is considered, which in addition to permitting more uniform distribution of the grey levels opens the possibility of applying a factor K equal to 3 or 11, while in the original version at 31 frames the non common division factor does not exist.

There is a particular non-binary code of the grays (for example with weights of the bits equal to 2, 4, 5, 8, 16 instead of 1, 2, 4, 8, 16) which, in addition to following the transmittance curve very well, through the application of a factor 5 indicates the initial 35 frames (5 bit are optimal for the current LCDs) at the value 7 suggested by the studies made on the Phase Tiling for absence of movie markee phenomenon of effective reduction of the flicker and makes the assessment of the weakest grey available instead of only one frame on two frames. In this manner the reduction of the frequency for availability of the weakest grey is obtained on two basic frames; the reduction of the frequency by means of the innovative technique herein described when the correct choice of the scale factor is made; the further reduction of the frequency by means of the suitable choice of the excellent distribution of the bits having the same weight (distancing of the two instants in which the same bit is assessed); the further reduction of the frequency if the scale factor chosen is at the same time compatible with the Phase Tiling or chosen just to start from Phase Tiling considerations.

We note that the considerations made regarding the grey scale naturally extend to the color through the color-filters applied to the display without anything described having to be changed.

In conclusion, no assumption has been made regarding the use of the scanned single row or the scanned multiple rows technique, therefore the technique described must be taken as valid for both the possibilities without distinctions.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A method for driving LCD modules having a multiplicity of display elements located at the intersections of a matrix having a plurality of row electrodes and a plurality of column electrodes, said method comprising the phases of:
applying an M bit electrical digital signal to at least one row electrode at a time, subdivided into a plurality of time intervals equal to 2^{M}−1;
said electrical digital signal suitable for illuminating each of said display elements with a predefined luminosity level chosen from among 2^{M} luminosity levels;
each of said M bits is applied for a preset duration; and
the preset duration of each of said M bits is then reduced in accordance with a predefined scale factor K and said M bits are subdivided into (2^{M}−1)/K pluralities of time intervals.

2. The method of claim 1 wherein said M bits are combined with each other so as to reduce the number of possible switches.

3. The method of claim 1 wherein said plurality of time intervals the bits that represent said 2^{M} luminosity levels in accordance with a predetermined scale of weights are subdivided.

4. The method of claim 3 wherein said predetermined scale of weights assesses each bit for a preset number of said plurality of time intervals.

5. The method of claim 4 wherein the instants of time in which a bit is assessed are distributed equally.

6. The method of claim 1 wherein said scale factor K is determined so as to minimize current consumption of said LCD modules.

7. The method of claim 1 wherein said scale factor K is determined so as to obtain a number of said plurality of time intervals in order to apply the technique known as Phase Tiling.

8. The method of claim 1 wherein said scale factor K is determined so as to obtain a number of said plurality of time intervals equal to one from among 7, 11, and 13.

9. A method for driving LCD modules having a plurality of display elements associated with a plurality of row electrodes and a plurality of column electrodes in a matrix, the method comprising:
illuminating each of the display elements with a predefined luminosity level chosen from among 2^{M} luminosity levels by applying an M-bit electrical digital signal to at least one row electrode at a time, the M-bit electrical digital signal subdivided into a plurality of time intervals equal to 2^{M}−1, each of said M-bits is applied for a preset duration; and
reducing the preset duration of each of said M-bits in accordance with a predefined scale factor K and subdividing M-bits into (2^{M}−1)/K plurality of time intervals.

10. The method of claim 9 wherein the M-bits in the plurality of time intervals represent the 2^{M} luminosity levels in accordance with a predetermined scale of weights.

11. The method of claim 10 wherein the predetermined scale of weights is used to assess each bit for a preset number of the plurality of time intervals.

12. A method for driving LCD modules having a multiplicity of display elements coupled to a plurality of row electrodes and a plurality of column electrodes arranged in a matrix, the method comprising:
illuminating each of the display elements with a predefined luminosity level chosen from among 2^{M} luminosity levels by applying an M-bit electrical digital signal to at least one row electrode at a time, the M-bit electrical digital signal subdivided into a plurality of time intervals equal to 2^{M}−1, each of said M-bits is applied for a preset duration; and
reducing the preset duration of each of said M-bits in accordance with a predefined scale factor K.

13. The method of claim 12, further comprising subdividing the M-bits into (2M-1)/K pluralities of time intervals.

14. The method of claim 13 wherein the scale factor K is determined so as to obtain a number of the plurality of time intervals in order to apply a Phase Tiling technique.

15. The method of claim 12 wherein the scale factor K is determined so as to obtain a number of the plurality of time intervals equal to one from among 7, 11, and 13 time intervals.

16. An LCD module, comprising:
an LCD display device having a multiplicity of display elements coupled to a plurality of row electrodes and a plurality of column electrodes arranged in a matrix; and
a circuit for driving the display elements, the circuit configured to illuminate each of the display elements with a predefined luminosity level chosen from among 2^{M} luminosity levels by applying an M-bit electrical digital signal to at least one row electrode at a time, the M-bit electrical digital signal subdivided into a plurality of time intervals equal to 2^{M}−1, each of said M-bits is applied for a preset duration, and then to reduce the preset duration of each of the M-bits in accordance with a predefined scale factor K and subdividing the M-bits into (2^{M}−1)/K plurality of time intervals.

17. An LCD module, comprising:
an LCD display device comprising a multiplicity of display elements coupled to a plurality of row electrodes and a plurality of column electrodes arranged in a matrix; and
a driving circuit for driving the display elements by illuminating each of the display elements with a predefined luminosity level chosen from among 2^{M} luminosity levels by applying an M-bit electrical digital signal to at least one row electrode at a time, the M-bit electrical digital signal subdivided into a plurality of time intervals equal to 2^{M}−1, each of said M-bits is applied for a preset duration, and then reducing the preset duration of each of said M-bits in accordance with a predefined scale factor K.

18. The module of claim 17 wherein the driver circuit is configured to subdivide the M bits into (2^{M}−1)/K pluralities of time intervals.

19. The module of claim 18 wherein the scale factor K is determined to obtain a number of the plurality of time intervals in order to apply a Phase Tiling technique.

20. The module of claim 18 wherein the scale factor K is determined so as to obtain a number of the plurality of time intervals equal to one from among 7, 11, and 13 time intervals.
